(19) United States
(12) Patent Application Publication
(10) Pub. No.: US 2024/0429420 A1
(43) Pub. Date: Dec. 26, 2024

(54) PRECIPITATE CONTROL, ACTIVE SPECIES CROSS-OVER MANAGEMENT AND REBALANCING STRATEGIES FOR REDOX FLOW BATTERIES

(71) Applicant: UOP LLC, Des Plaines, IL (US)

(72) Inventors: Zara Osman, Glenview, IL (US); Maria Padilla, Des Plaines, IL (US); Charles P. McGonegal, Bristol, WI (US); David E. Gray, Homer Glen, IL (US)

(21) Appl. No.: 18/589,976

(22) Filed: Feb. 28, 2024

Related U.S. Application Data
(60) Provisional application No. 63/509,984, filed on Jun. 23, 2023.

(51) Int. Cl. H01M 8/18; H01M 8/04082; H01M 8/04276; H01M 8/04746

(52) U.S. Cl. CPC H01M 8/188; H01M 8/04201; H01M 8/04276; H01M 8/04753

(57) ABSTRACT

Redox flow battery systems are described. The redox flow battery systems include a main cell and a three-chambered rebalancing cell. The system can optionally also include a two-chambered rebalancing cell. The three-chambered rebalancing cell and two-chambered rebalancing cell can be operated alternately, in parallel, or in series. Methods of operating the redox flow battery systems are also described.

### RELATED APPLICATIONS

This application claims priority to U.S. Provisional Patent Application Ser. No. 63/509,984, filed on Jun. 23, 2023, the entirety of which is incorporated herein by reference.

### BACKGROUND

The world electric generation capacity is expected to increase to greater than 35,000 TWh by 2040. Energy needs will likely expand by nearly 30% by 2040. Among the most abundant sources are solar and wind, which has seen a rise from 3% in 2010 to 13% in 2021 and is continuously increasing. However, the drawbacks to wing and solar energy lie in their variable nature because they are inconsistent and not reliable given their dependency on factors such as cloud cover and wind speed. To utilize such resources on a large scale, the solution could lie in energy storage. Electrical energy storage (EES) can store energy when it is most readily available and release it during times of peak need. While only about 3% of the installed generation capacity in the U.S. is supplied from EES, US battery storage has grown from less than 60 MW in 2010 to 8,246 MW in Q3 2022. Large scale battery storage capacity is expected to grow from 1 GW in 2019 to 80 GW in 2030.

Consequently, there is a growing need for long-duration energy storage. For instance, an electric grid that is 80% powered by solar/wind would require about 12 h of storage. The US DOEs Energy Earthshot Initiative aims to reduce cost of grid-scale energy storage by 90% for 10 h+ systems. 95% of long duration storage in the US is powered by pumped-storage hydropower, but this is limited by geography. Most grid-scale batteries are rechargeable intercalation batteries such as Li-ion batteries which, although they have high energy density and long cycle-life, suffer from issues of safety and high cost, thus limiting their applications. They are also difficult to scale: if more capacity is needed, more batteries need to be added.

An attractive alternative for stationary applications, are redox flow batteries (RFBs) which store energy in tanks of liquid electrolytes and hence decouple power and capacity. The energy is stored in the volume of electrolyte, while the power capability is determined by the size of the electrochemical cell stacks. Hence, they can deliver kilowatt to megawatt-hours of energy while mitigating system vulnerabilities such as uncontrolled energy release in the instance of a fault condition. At the end of 2019, flow batteries were about 1% of large-scale battery installations in the US.

Currently, the most widely studied flow batteries are the traditional vanadium and zinc-based redox flow batteries. Although these are close to commercialization, their applications are limited due to relatively low power and energy densities. Most large-scale redox flow batteries installed in 2016-2017 were based on vanadium redox batteries, which fully decouple power and energy; however, they are cost-prohibitive, and use toxic and corrosive materials. Other alternatives rely on plating chemistries such as the iron slurry battery, where iron is plated on particles in a slurry to store energy externally in a tank, but these have issues of clogging.

The all-iron flow battery has been identified as a potential area of interest due to its low cost, environmental friendliness, and the abundance and low toxicity of iron. This system employs a Fe²⁺/Fe⁰ redox couple on the negative side and a Fe²⁺/Fe³⁺ redox couple on the positive side. Having similar active species on both sides of the battery help circumvent the issue of employing expensive separator materials to prevent cross contamination of the redox species. However, due to the undesired side reaction of H₂ evolution (explained in detail below), there is a need to maintain the pH of the negative electrolyte at least above 3 but not greater than about 4.5 due to Fe²⁺ precipitation. On the other hand, the Fe³⁺ generated on positive side of the battery precipitates at a pH greater than 3, and therefore in the event of Fe³⁺ migration from the positive to the negative side of the battery, there is a risk of precipitation within the separator as well as clogging of the anode, thus exacerbating cell resistance and severely limiting cycle life.

Several methods of pH control have been discussed in the literature, but most either rely on passive H⁺ diffusion, which may be limited by the membrane of choice, or alter the chemistry of the electrolytes during the process in the case of active control such as acid additions, which may not be desirable in the longer term.

One of the major challenges of the all-iron flow battery chemistry is the generation of H₂ at the anode during the charging process. The electrochemistry is indicated in the three equations below:

$$\begin{matrix}{Fe}^{3 +} + {e}^{-} \to {Fe}^{2 +} {E}^{0} = + 0.77 V & ( 1 ) \\ {Fe}^{2 +} + 2 {e}^{-} \to {Fe}^{0} {E}^{0} = - 0.44 V & ( 2 ) \\ 2 {Fe}^{2 +} + {Fe}^{2 +} \to 2 {Fe}^{3 +} + {Fe}^{0} {E}^{0} = + 1.21 V & ( 3 )\end{matrix}$$

where Eq. 1 is the reaction on the positive side, Eq. 2 is the reaction on the negative side, and Eq. 3 is the full cell reaction totaling a theoretical voltage of +1.21 V. These reduction potentials are given on the Standard Hydrogen Electrode scale where 0V is the reduction of H⁺ to H₂ (given in Eq. 4).

$$2 {H}^{+} + 2 {e}^{-} \to {H}_{2} {E}^{0} = 0 V \qquad ( 4 )$$

Because the reduction potential for the reduction of Fe²⁺ to Fe⁰ is more negative than the reduction potential for H⁺ to H₂, during charging (Fe plating) production of H₂ gas is thermodynamically more favorable than Fe⁰ plating. H₂ gas production is observed on the negative side of the battery. This leads to several issues including precipitation of Fe²⁺ and Fe³⁺ oxides and hydroxides on the negative side leading to cell clogging, and electrolyte imbalance from Fe³⁺ build-up on the positive side, resulting in shortened cycle-life.

To help mitigate this, several rebalancing strategies have been disclosed, one of which is the electrochemical approach that relies on utilizing H₂ generated at the anode to react with Fe³⁺ in the catholyte to reduce it to Fe²⁺ and H⁺. The main drawback of this approach is that the H⁺ is introduced into the catholyte and the need to rely on diffusion through the separator to be put back into the anolyte to help maintain pH.

Another version of the electrochemical balancing cell involves a three-chambered approach where the anolyte flows through a middle compartment within the hydrogen rebalancing cell separated on two sides with either cation exchange membranes or microporous separators or a combination thereof. This helps move H⁺ directly into the anolyte, but there are undesired side-effects of solely relying on this means of recombination. One is excessively low pH of the anolyte leading to high levels of H₂ evolution, thus resulting in low coulombic efficiencies. Another drawback of this approach is the subsequent movement of another positive ion from the negative to the positive electrolyte with the rebalancing cell, leading to electrolyte imbalance and precipitation of salts on the separator between the positive and negative electrolyte compartments which limits cycle life.

Therefore, there is a need to employ a separator that prevents Fe³⁺ cross-over while maintaining the appropriate pH of the anolyte.

### BRIEF DESCRIPTION OF THE DRAWINGS

FIG. 1 is an illustration of one embodiment of a redox flow battery system with a single rebalancing cell according to the present invention.

FIG. 2-3 are illustrations of one embodiment of a redox flow battery system with flow alternating between two rebalancing cells according to the present invention.

FIG. 4 is an illustration of one embodiment of a redox flow battery system with flow going to both of the rebalancing cells according to the present invention.

FIG. 5 is an illustration of one embodiment of a redox flow battery system with flow going from the rebalancing cell to the second rebalancing cell according to the present invention.

FIG. 6 is an illustration of one embodiment of a redox flow battery system with flow going from the second rebalancing cell to the rebalancing cell according to the present invention.

### DESCRIPTION

The present invention addresses both management of cross-over of active species and supporting species, as well as maintaining the pH of the anolyte. In some embodiments, this is achieved using an AEM in the main cell in combination with a three-chambered hydrogen rebalancing cell with an AEM suspended between the positive and negative electrolyte compartments along with either a cation exchange membrane, a bipolar membrane, or a microporous separator between the negative electrolyte compartment and the H₂ side of the rebalancing cell. This approach also helps address the issue of positive ion build-up in the catholyte because as H⁺ ions are introduced into the anolyte, there is subsequent negative ion movement from the catholyte toward the anolyte. Because the main Fe/Fe cell also uses an AEM membrane, the negative ion would have originally moved from the anolyte toward the catholyte during the charging process and is therefore restored in the rebalancing cell.

The three-chambered rebalancing cell comprises a positive electrolyte chamber, a negative electrolyte chamber, and a hydrogen gas compartment which are connected to the positive electrolyte tank, the negative electrolyte tank, and the tank headspace of the negative electrolyte tank respectively. An ion-exchange membrane, bipolar membrane or a microporous separator separates the two sides of the cell. The headspaces of the positive and negative electrolyte tanks may or may not be connected. Electrolyte flow may alternate between the two rebalancing cells, be in series from the main cell to the first and second rebalancing cells, or be in parallel from the main cell to each of the two rebalancing cells in order to enable flow control during inactive phases of each rebalancing cell.

This approach accomplishes three things: helping to limit active and supporting species cross-over during battery cycling; helping to maintain the pH of the anolyte by moving H⁺ directly into the anolyte stream during rebalancing; and avoiding electrolyte imbalances by allowing for negative ion movement both in the main cell, as well as in the rebalancing cell.

Alternatively, when the separator of the main cell comprises a proton exchange membrane, a cation exchange membrane, or a microporous separator, the first separator of the rebalancing cell may comprise a proton exchange membrane, a cation exchange membrane, or a microporous separator, and the second separator of the rebalancing cell may comprise a proton exchange membrane, a cation exchange membrane, or a microporous separator.

The three-chambered rebalancing cell can be combined with a two-chambered rebalancing cell in a dual hydrogen rebalancing approach to swing back-and-forth between the two methods of hydrogen recombination to maintain the pH with a narrow range. The two-chambered rebalancing cell comprises a positive electrolyte chamber and a hydrogen gas chamber which are connected to the positive electrolyte tank and the headspace of the negative electrolyte tank respectively. An ion-exchange membrane, bipolar membrane or a microporous separator separates the two sides of the cell.

The control strategy for the redox flow battery system comprising the three-chambered rebalancing cell and the two-chambered rebalancing cell can rely on monitoring one or more of pH, pressure, turbidity, cell voltage, or any other optical or electrochemical means of monitoring state of charge. When the value of any of these goes above the set point specified, the relevant hydrogen rebalancing cell becomes “activated” while the other recombination cell is either “active” or simultaneously becomes “deactivated”. The electrolyte flow can be controlled to circumvent the deactivated cell, or it can continue to flow through both cells. This approach has several benefits: helping to limit or eliminate precipitate formation while controlling/maximizing coulombic efficiency; helping to maintain the pH of the anolyte by moving H⁺ directly into the anolyte stream during rebalancing based on control strategy in a way that the pH is lowered in a controlled manner; and avoiding electrolyte imbalances and precipitation by swinging between the two rebalancing cells and allowing for equilibration of other salts. It also has the potential for managing water movement across the membrane.

The main cell of the battery system comprises a negative electrolyte chamber coupled with the negative electrode and a positive electrolyte chamber coupled with the positive electrode. A separator separates the two sides of the main cell. The positive electrolyte chamber is connected to the positive electrolyte chamber of the rebalancing cell and the negative electrolyte chamber is connected to the negative electrolyte chamber of the rebalancing cell. The H₂ generated on the negative side in the main battery stack is coupled with the negative electrode in the hydrogen chamber of the rebalancing cell. The battery stack can include one or more main cells, as is known in the art. A negative electrolyte chamber in the rebalancing cell comprises the negative electrolyte flowing from the negative electrolyte chamber in the main cell and returning to the negative electrolyte tank. There is a first separator between the positive and negative electrolyte chambers of the rebalancing cell, and a second separator between the hydrogen and negative electrolyte chambers. During charging, ion conduction of one or more negative ion(s) such as F⁻, Cl⁻, Br⁻, I⁻, SO₄²⁻+ from the negative electrolyte toward the positive electrolyte helps maintain charge balance in the main cell, while H⁺ recovered from the rebalancing cell (originally lost through H₂ evolution at the negative electrode) is returned to the negative electrolyte from the H₂ side of the rebalancing cell. Subsequently, to maintain charge balance, negative ions are conducted from the positive electrolyte toward the negative electrolyte in the rebalancing cell.

This helps limit active and supporting species cross-over in the main stack, while also addressing the issue of maintaining pH to avoid precipitates at the negative electrode, thereby improving longevity of these batteries.

Based on the set control strategy, one of the cells could be turned on while the other is simultaneously turned off in response to a trigger. For example, if the pH rises above a predetermined set point, the two-chambered cell can be turned “off”, while the three-chambered cell is turned “on”. The control strategy can rely on monitoring any one or more of pH, pressure, turbidity, cell voltage, or any other optical or electrochemical means of state of charge monitoring. Further, the “on” or “off” status of the recombination cell can be determined in a variety of ways, such as whether current flows through the cell or by the presence or absence of electrolyte flow.

If the value of the parameter being monitored (for example pH) rises above the set point, the three-chambered cell can actively help move protons into the negative electrolyte until the low set-point value triggers the two-chambered cell to now become active and help keep the pH from falling any further. The reverse can happen if the pH goes below the lower set-point.

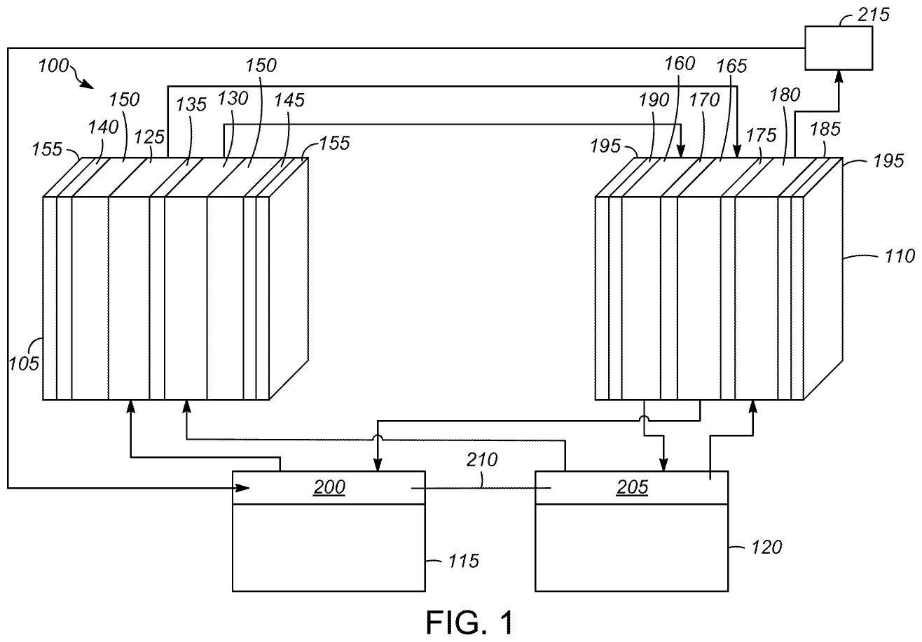

FIG. 1 illustrates a redox flow battery system 100 comprising a main cell 105, a rebalancing cell 110, a negative electrolyte tank 115 and a positive electrolyte tank 120.

The main cell 105 includes a negative electrolyte chamber 125 and a positive electrolyte chamber 130 separated by a separator 135. There is a negative electrode 140 and a positive electrode 145. The main cell may also include a pair of conductive substrates, non-conductive substrates, or combinations thereof 150 and a pair of bipolar plates 155. In some embodiments, the conductive and/or non-conductive substrates may be contained in the electrolyte chambers, and in other embodiments, they are separate from the electrolyte chambers.

The rebalancing cell 110 includes a positive electrolyte chamber 160 and a negative electrolyte chamber 165 separated by a first separator 170. There is a second separator 175 between the negative electrolyte chamber 165 and the hydrogen chamber 180. There is a negative electrode 185 and a positive electrode 190. The rebalancing cell 110 may also include a pair of bipolar plates 195.

The negative electrolyte flows from the negative electrolyte tank 115 to the negative electrolyte chamber 125 of the main cell 105, and the positive electrolyte flows from the positive electrolyte tank 120 to the positive electrolyte chamber 130 of the main cell 105.

The negative electrolyte then flows to the negative electrolyte chamber 165 of the rebalancing cell 110, and the positive electrolyte flows to the positive electrolyte chamber 160 of the rebalancing cell 110.

The negative electrolyte flows from the negative electrolyte chamber 165 of the rebalancing cell 110 to the negative electrolyte tank 115, and the positive electrolyte flows from the positive electrolyte chamber 160 of the rebalancing cell 110 to the positive electrolyte tank 120.

The tank headspace comprises the headspace 200 of the negative electrolyte tank 115 and headspace 205 of the positive electrolyte tank 120 and the connector 210 between the two. Hydrogen gas flows from the tank headspace to the hydrogen chamber 180. The hydrogen from the hydrogen chamber 180 can flow to an optional hydrogen source, compressor, or both 215 and from there back to the tank headspace.

The separator of the main cell may comprise a proton exchange membrane, a cation exchange membrane, or a microporous separator. In this case, the first separator of the rebalancing cell comprises a proton exchange membrane, a cation exchange membrane, or a microporous separator, and the second separator of the rebalancing cell comprises a proton exchange membrane, a cation exchange membrane, or a microporous separator. The first and second separators can be the same or different. Desirably, the separator of the main cell is of the same type as the first separator.

The separator of the main cell may comprise an anion exchange membrane. In this case, the first separator of the rebalancing cell comprises an anion exchange membrane and the second separator of the rebalancing cell may comprise a proton exchange membrane, a cation exchange membrane, or a microporous separator. The purpose of the second separator in the three-chambered cell is to move H⁺ ions or other positive ions to maintain the charge balance.

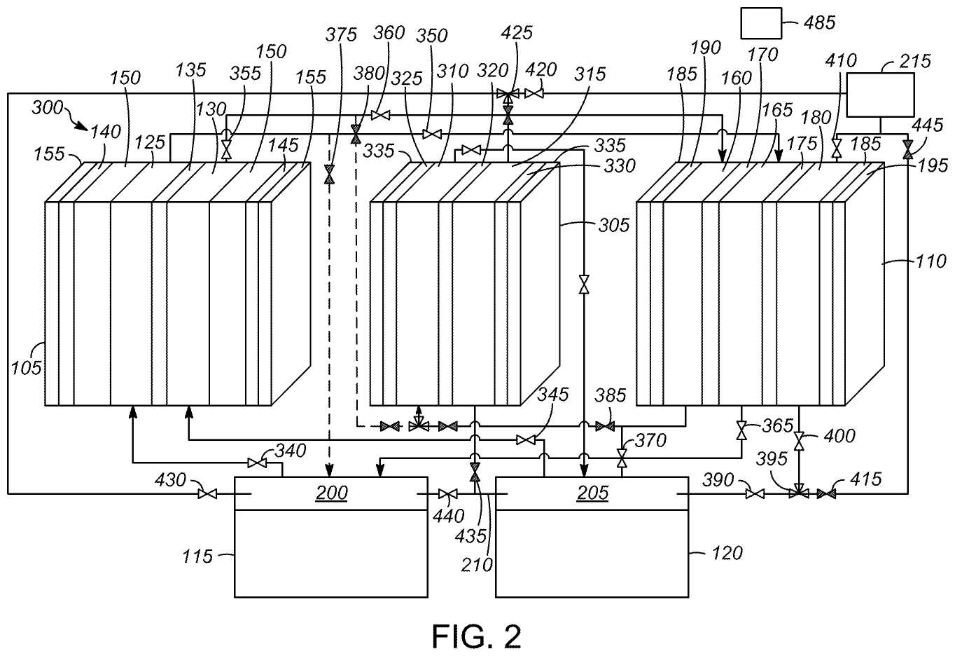

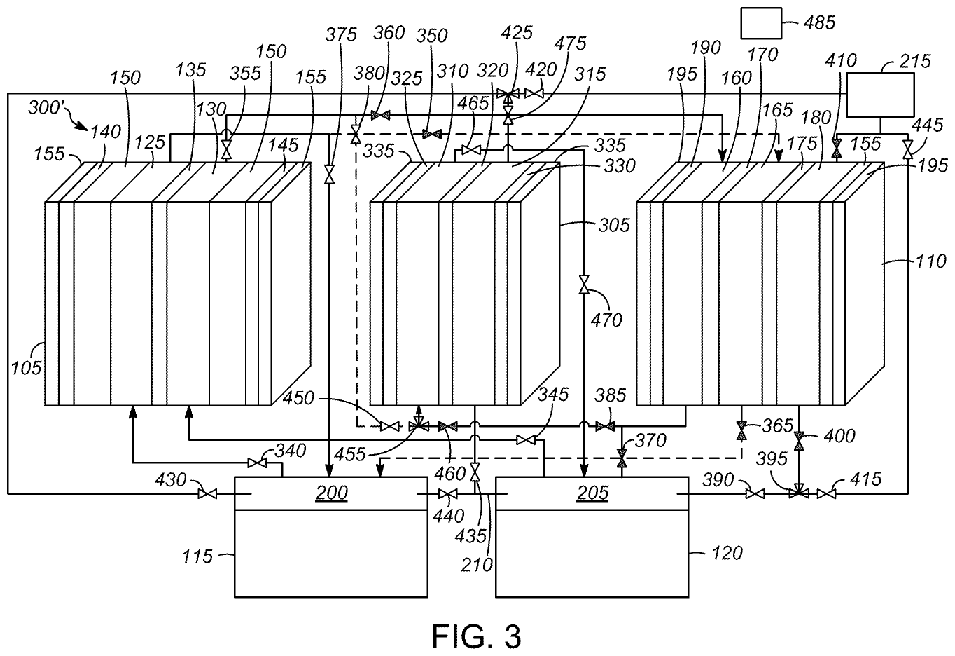

FIGS. 2-3 illustrate a redox flow battery system 300 including a second rebalancing cell 305. The electrolyte flow alternates between the rebalancing cell 110 and the second rebalancing cell 305. As shown in FIG. 2, when the pH is greater than a predetermined set point, only rebalancing cell 110 is used. In FIG. 3, when the pH is less than the predetermined set point, only the second rebalancing cell 305 is used.

FIG. 2 shows the redox flow battery system comprising a main cell 105, a rebalancing cell 110, a negative electrolyte tank 115 and a positive electrolyte tank 120, as described above.

There is also a second rebalancing cell 305 which includes a positive electrolyte chamber 310 and a hydrogen chamber 315 separated by a separator 320. There is a positive electrode 325 and a negative electrode 330 which are surrounded by a pair of bipolar plates 335.

When the pH is greater than the predetermined set point, valve 340 is open, allowing the negative electrolyte to flow from the negative electrolyte tank 115 to the negative electrolyte chamber 125 of the main cell 105, and valve 345 is open allowing the positive electrolyte to flow from the positive electrolyte tank 120 to the positive electrolyte chamber 130 of the main cell 105.

The negative electrolyte then flows through open valve 350 to the negative electrolyte chamber 165 of the rebalancing cell 110. The positive electrolyte flows from the positive electrolyte chamber 130 of the main cell 105 through open valves 355, 360 to the positive electrolyte chamber 160 of the rebalancing cell 110.

The negative electrolyte flows from the negative electrolyte chamber 165 of the rebalancing cell 110 to the negative electrolyte tank 115 through open valve 365, and the positive electrolyte flows from the positive electrolyte chamber 160 of the rebalancing cell 110 to the positive electrolyte tank 120 through open valve 370.

Valve 375 is closed to prevent the negative electrolyte from the main cell 105 flowing to the negative electrolyte tank 115. Valve 380 is closed to prevent positive electrolyte from the positive electrolyte chamber 130 of the main cell 105 from flowing to the positive electrolyte chamber 310 of the second rebalancing cell 305, and valve 385 is closed to prevent positive electrolyte from the positive electrolyte chamber 160 of the rebalancing cell 110 from flowing to the positive electrolyte chamber 310 of the second rebalancing cell 305.

In this way, negative electrolyte flows from the negative electrolyte tank 115 to the negative electrolyte chamber 125 of the main cell 105, then to the negative electrolyte chamber 165 of the rebalancing cell 110, and back to the negative electrolyte tank 115. Positive electrolyte flows from the positive electrolyte tank 120 to the positive electrolyte chamber 130 of the main cell 105, then to the positive electrolyte chamber 160 of the rebalancing cell 110, and back to the positive electrolyte tank 120.

Hydrogen gas flows from the tank headspace to the hydrogen chamber 180 in the rebalancing cell 110 through open valves 390, 395, 400, and from the hydrogen chamber 180 to the hydrogen source and/or compressor 215 through open valve 410. Valve 415 is closed to prevent hydrogen flow from the tank headspace to the hydrogen source and/or compressor 215. Hydrogen flows from the hydrogen source and/or compressor 215 through open valves 420, 425, 430 to the tank headspace. Valve 435 is closed to prevent hydrogen from flowing to the hydrogen chamber 315 of the second rebalancing cell 305. There can be an open valve 440 on the connector 210 between the headspace 200 of the negative electrolyte tank and the headspace 205 of the positive electrolyte tank 120.

The flow of the positive electrolyte and the negative electrolyte from the main cell to the rebalancing cells 110 and 305 can be controlled by a controller 485. The controller 485 can control the various valves allowing flow of some, all, or none of the positive electrolyte and negative electrolyte to flow to the rebalancing cell 110 and the second rebalancing cell 305 depending on the mode of operation as discussed above. In addition to controlling the valves allowing and/or restricting electrolyte flow, the controller 485 can control the flow of current to either or both of the rebalancing cells 110 and 305 depending on the mode of operation.

As shown in FIG. 3, when the pH is less than S.P., valves 340 and 345 are open, allowing the negative electrolyte to flow from the negative electrolyte tank 115 to the negative electrolyte chamber 125 of the main cell 105, and the positive electrolyte to flow from the positive electrolyte tank 120 to the positive electrolyte chamber 130 of the main cell 105.

Valve 350 is closed preventing the negative electrolyte from flowing to the rebalancing cell 110, and valve 360 is closed preventing the positive electrolyte from flowing to the rebalancing cell 110. Valve 375 is open allowing the negative electrolyte to flow from the negative electrolyte chamber 125 of the main cell 105 to the negative electrolyte tank 115.

The positive electrolyte flows through open valves 355, 380, 450, 455 from the positive electrolyte chamber 130 of the main cell 105 to the positive electrolyte chamber 310 of the second rebalancing cell 305. Valve 460 is closed to prevent positive electrolyte from flowing beyond the second rebalancing cell 305. The positive electrolyte flows from the positive electrolyte chamber 310 of the second rebalancing cell 305 through open valves 465, 470 to the positive electrolyte tank 120.

Valves 365, 370, 385 may be closed to isolate the rebalancing cell 110.

Thus, negative electrolyte flows from the negative electrolyte tank 115 to the negative electrolyte chamber 125 of the main cell 105 and back to the negative electrolyte tank 115. Positive electrolyte flows from the positive electrolyte tank 120 to the positive electrolyte chamber 130 of the main cell 105, then to the positive electrolyte chamber 310 of the second rebalancing cell 305, and back to the positive electrolyte tank 120.

Hydrogen gas flows from the tank headspace to the hydrogen source and/or compressor 215 through open valves 390, 395, 415, 445. Valve 400 is closed to prevent hydrogen flow from the tank headspace to the hydrogen chamber 180 of the rebalancing cell 110. Hydrogen flows from the hydrogen source and/or compressor 215 through open valves 420, 425, 430 to the tank headspace. Valve 435 is open to allow hydrogen to flow from the tank headspace to the hydrogen chamber 315 of the second rebalancing cell 305. Hydrogen flows from the hydrogen chamber 315 of the second rebalancing cell through open valves 475, 425, 430 to the tank headspace. There can be an open valve 440 on the connector 210 between the headspace 200 of the negative electrolyte tank and the headspace 205 of the positive electrolyte tank 120.

The flow of the positive electrolyte and the negative electrolyte from the main cell to the rebalancing cells 110 and 305 can be controlled by a controller 485. The controller 485 can control the various valves allowing flow of some, all, or none of the positive electrolyte and negative electrolyte to flow to the rebalancing cell 110 and the second rebalancing cell 305 depending on the mode of operation as discussed above. In addition to controlling the valves allowing and/or restricting electrolyte flow, the controller 485 can control the flow of current to either or both of the rebalancing cells 110 and 305 depending on the mode of operation.

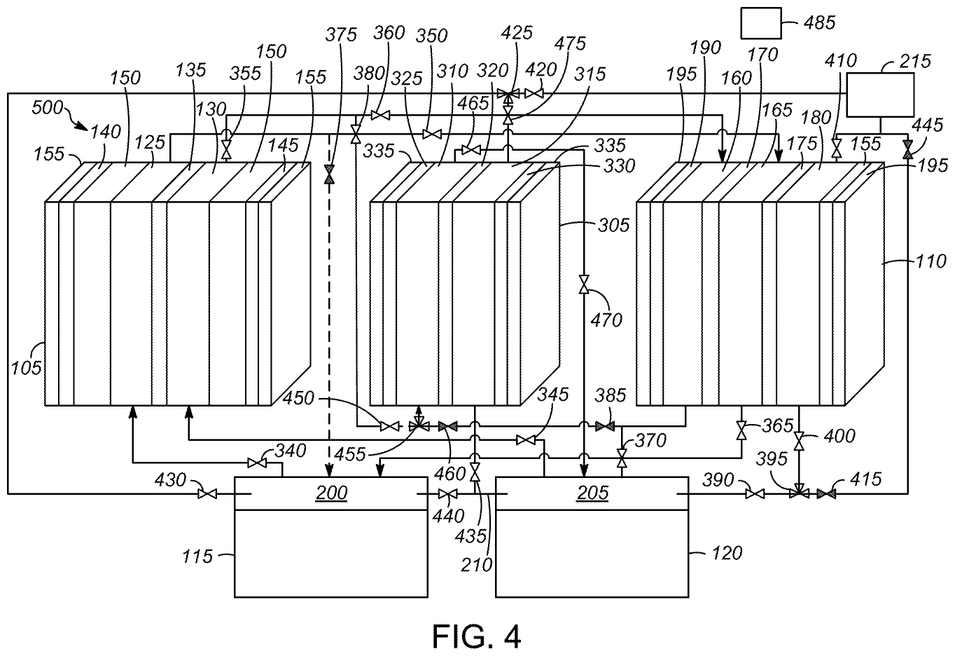

FIG. 4 shows the redox flow battery system 500 comprising a main cell 105, a rebalancing cell 110, a negative electrolyte tank 115, a positive electrolyte tank 120, and a second rebalancing cell 305, as described above. This arrangement allows parallel flow to the rebalancing cell 110 and the second rebalancing cell 305.

The negative electrolyte flows from the negative electrolyte tank 115 to the negative electrolyte chamber 125 of the main cell 105 though open valve 340, and the positive electrolyte flows from the positive electrolyte tank 120 to the positive electrolyte chamber 130 of the main cell 105 though open valve 345.

The negative electrolyte then flows through open valve 350 to the negative electrolyte chamber 165 of the rebalancing cell 110. A portion of the positive electrolyte flows from the positive electrolyte chamber 130 of the main cell 105 through open valves 355, 360 to the positive electrolyte chamber 160 of the rebalancing cell 110. Another portion of the positive electrolyte from the positive electrolyte chamber 130 of the main cell 105 flows through open valves 355, 380, 450, 455 to the positive electrolyte chamber 310 of the second rebalancing cell 305.

The negative electrolyte flows from the negative electrolyte chamber 165 of the rebalancing cell 110 to the negative electrolyte tank 115 through open valve 365, and the positive electrolyte flows from the positive electrolyte chamber 160 of the rebalancing cell 110 to the positive electrolyte tank 120 through open valve 370. Valve 375 is closed to prevent the negative electrolyte from the main cell 105 flowing to the negative electrolyte tank 115.

The positive electrolyte from the positive electrolyte chamber 310 of the second rebalancing cell 305 flows to the positive electrolyte tank 120 through open valves 465, 470.

Valve 385 is closed to prevent positive electrolyte from the positive electrolyte chamber 160 of the rebalancing cell 110 from flowing to the positive electrolyte chamber 310 of the second rebalancing cell 305. Valve 460 is closed to prevent positive electrolyte from the positive electrolyte chamber 130 of the main cell 105 from bypassing the second rebalancing cell 305.

In this way, negative electrolyte flows from the negative electrolyte tank 115 to the negative electrolyte chamber 125 of the main cell 105, then to the negative electrolyte chamber 165 of the rebalancing cell 110, and back to the negative electrolyte tank 115. Positive electrolyte flows from the positive electrolyte tank 120 to the positive electrolyte chamber 130 of the main cell 105, then to the positive electrolyte chamber 160 of the rebalancing cell 110, and back to the positive electrolyte tank 120. In addition, positive electrolyte flows from the positive electrolyte chamber 130 of the main cell 105 to the positive electrolyte chamber 310 of the second rebalancing cell 305 and then to the positive electrolyte tank 120.

Hydrogen gas flows from the tank headspace to the hydrogen chamber 180 in the rebalancing cell 110 through open valves 390, 395, 400, and from the hydrogen chamber 180 to the hydrogen source and/or compressor 215 through open valve 410. Valve 415 is closed to prevent hydrogen flow from the tank headspace to the hydrogen source and/or compressor 215. Hydrogen flows from the hydrogen source and/or compressor 215 through open valves 420, 425, 430 to the tank headspace. Valve 435 is open to allow hydrogen to flow from the tank headspace to the hydrogen chamber 315 of the second rebalancing cell 305. Hydrogen from the hydrogen chamber 315 of the second rebalancing cell 305 flows through valve 475, 425, 430 to the tank headspace. There can be an open valve 440 on the connector 210 between the headspace 200 of the negative electrolyte tank and the headspace 205 of the positive electrolyte tank 120.

The flow of the positive electrolyte and the negative electrolyte from the main cell to the rebalancing cells 110 and 305 can be controlled by a controller 485. The controller 485 can control the various valves allowing flow of some, all, or none of the positive electrolyte and negative electrolyte to flow to the rebalancing cell 110 and the second rebalancing cell 305 depending on the mode of operation as discussed above. In addition to controlling the valves allowing and/or restricting electrolyte flow, the controller 485 can control the flow of current to either or both of the rebalancing cells 110 and 305 depending on the mode of operation.

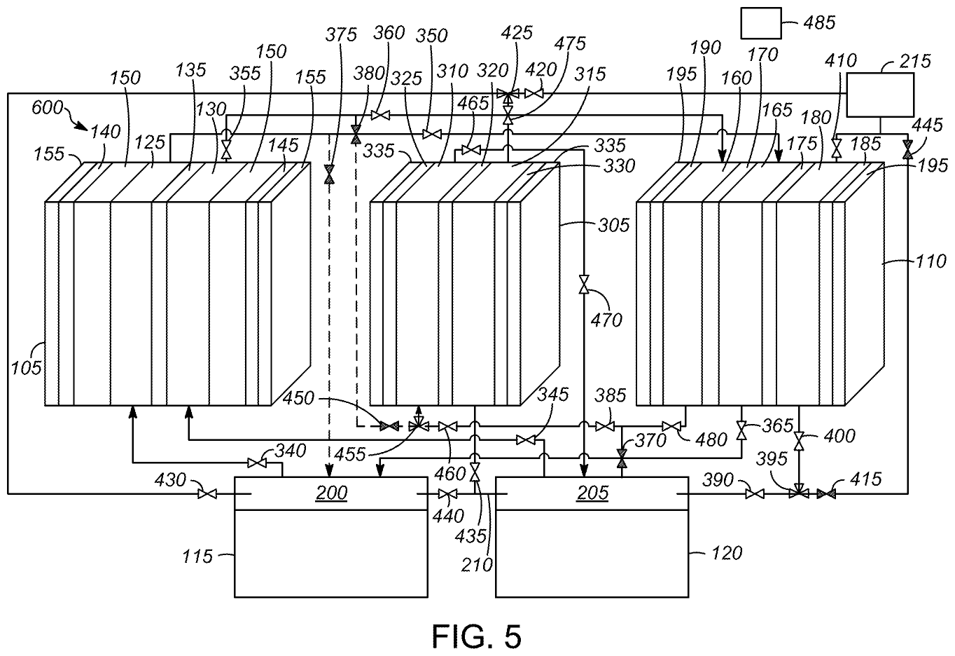

FIG. 5 shows the redox flow battery system 600 comprising a main cell 105, a rebalancing cell 110, a negative electrolyte tank 115, a positive electrolyte tank 120, and a second rebalancing cell 305, as described above. This arrangement allows positive electrolyte flow in series from the main cell 105 to the rebalancing cell 110 and from the rebalancing cell to the second rebalancing cell 305, and then to the positive electrolyte tank 120.

The negative electrolyte flows from the negative electrolyte tank 115 to the negative electrolyte chamber 125 of the main cell 105 though open valve 340, and the positive electrolyte flows from the positive electrolyte tank 120 to the positive electrolyte chamber 130 of the main cell 105 though open valve 345.

The negative electrolyte then flows through open valve 350 to the negative electrolyte chamber 165 of the rebalancing cell 110. The positive electrolyte flows from the positive electrolyte chamber 130 of the main cell 105 through open valves 355, 360 to the positive electrolyte chamber 160 of the rebalancing cell 110.

The negative electrolyte flows from the negative electrolyte chamber 165 of the rebalancing cell 110 to the negative electrolyte tank 115 through open valve 365. Valve 375 is closed to prevent the negative electrolyte from the main cell 105 flowing to the negative electrolyte tank 115.

The positive electrolyte from the positive electrolyte chamber 160 of the rebalancing cell 110 flows to the positive electrolyte chamber 310 of the second rebalancing cell 305 through open valves 480, 385, 460, 455. The positive electrolyte from the positive electrolyte chamber 310 of the second rebalancing cell 305 flows to the positive electrolyte tank 120 through open valves 465, 470.

Valve 370 is closed to prevent positive electrolyte from the positive electrolyte chamber 160 of the rebalancing cell 110 from flowing to the positive electrolyte tank 120. Valve 450 is closed to prevent positive electrolyte from the positive electrolyte chamber 160 of the rebalancing cell 110 from bypassing the second rebalancing cell 305.

In this way, negative electrolyte flows from the negative electrolyte tank 115 to the negative electrolyte chamber 125 of the main cell 105, then to the negative electrolyte chamber 165 of the rebalancing cell 110, and back to the negative electrolyte tank 115. Positive electrolyte flows from the positive electrolyte tank 120 to the positive electrolyte chamber 130 of the main cell 105, then to the positive electrolyte chamber 160 of the rebalancing cell 110. The positive electrolyte flows from the positive electrolyte chamber 160 of the rebalancing cell 110 then flows to the positive electrolyte chamber 310 of the second rebalancing cell 305 and back to the positive electrolyte tank 120.

Hydrogen gas flows from the tank headspace to the hydrogen chamber 180 in the rebalancing cell 110 through open valves 390, 395, 400, and from the hydrogen chamber 180 to the hydrogen source and/or compressor 215 through open valve 410. Valve 415 is closed to prevent hydrogen flow from the tank headspace to the hydrogen source and/or compressor 215. Hydrogen flows from the hydrogen source and/or compressor 215 through open valves 420, 425, 430 to the tank headspace. Valve 435 is open to allow hydrogen to flow from the tank headspace to the hydrogen chamber 315 of the second rebalancing cell 305. Hydrogen from the hydrogen chamber 315 of the second rebalancing cell 305 flows through valve 475, 425, 430 to the tank headspace. There can be an open valve 440 on the connector 210 between the headspace 200 of the negative electrolyte tank 115 and the headspace 205 of the positive electrolyte tank 120.

The flow of the positive electrolyte and the negative electrolyte from the main cell to the rebalancing cells 110 and 305 can be controlled by a controller 485. The controller 485 can control the various valves allowing flow of some, all, or none of the positive electrolyte and negative electrolyte to flow to the rebalancing cell 110 and the second rebalancing cell 305 depending on the mode of operation as discussed above. In addition to controlling the valves allowing and/or restricting electrolyte flow, the controller 485 can control the flow of current to either or both of the rebalancing cells 110 and 305 depending on the mode of operation.

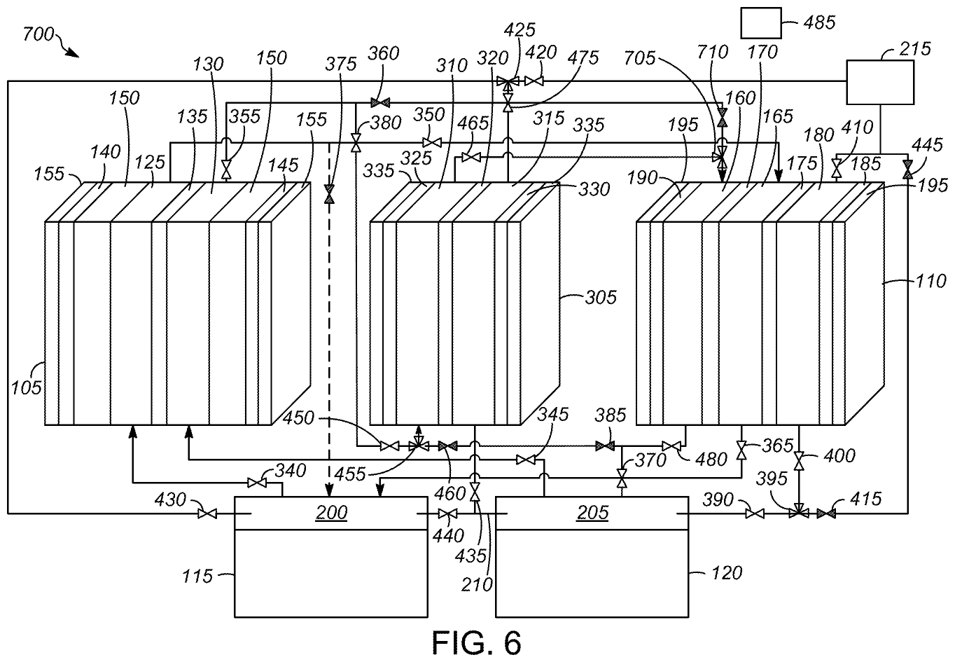

FIG. 6 shows the redox flow battery system 700 comprising a main cell 105, a rebalancing cell 110, a negative electrolyte tank 115, a positive electrolyte tank 120, and a second rebalancing cell 305, as described above. This arrangement allows positive electrolyte flow in series from the main cell 105 to the second rebalancing cell 305 and from the second rebalancing cell 305 to the rebalancing cell 110, and then to the positive electrolyte tank 120.

The negative electrolyte flows from the negative electrolyte tank 115 to the negative electrolyte chamber 125 of the main cell 105 though open valve 340, and the positive electrolyte flows from the positive electrolyte tank 120 to the positive electrolyte chamber 130 of the main cell 105 though open valve 345.

The negative electrolyte then flows through open valve 350 to the negative electrolyte chamber 165 of the rebalancing cell 110. The negative electrolyte flows from the negative electrolyte chamber 165 of the rebalancing cell 110 to the negative electrolyte tank 115 through open valve 365. Valve 375 is closed to prevent the negative electrolyte from the main cell 105 flowing to the negative electrolyte tank 115.

The positive electrolyte flows from the positive electrolyte chamber 130 of the main cell 105 through open valves 355, 380, 450, 455 to the positive electrolyte chamber 310 of the second rebalancing cell 305. Valves 360 and 710 are closed to prevent positive electrolyte from the main cell 105 from flowing to the positive electrolyte chamber 160 of the rebalancing cell 110. Valve 460 is closed to prevent positive electrolyte from bypassing the positive electrolyte chamber 310 of the second rebalancing cell 305.

The positive electrolyte from the positive electrolyte chamber 310 of the second rebalancing cell 305 flows to the positive electrolyte chamber 160 of the rebalancing cell 110 through open valves 465, 705. The positive electrolyte flows through open valves 480, 370 to the positive electrolyte tank 120.

Valve 385 is closed to prevent positive electrolyte from the positive electrolyte chamber 160 of the rebalancing cell 110 from flowing to the positive electrolyte chamber of the second rebalancing cell 305.

In this way, negative electrolyte flows from the negative electrolyte tank 115 to the negative electrolyte chamber 125 of the main cell 105, then to the negative electrolyte chamber 165 of the rebalancing cell 110, and back to the negative electrolyte tank 115. Positive electrolyte flows from the positive electrolyte tank 120 to the positive electrolyte chamber 130 of the main cell 105, then to the positive electrolyte chamber 310 of the second rebalancing cell 305. The positive electrolyte flows from the positive electrolyte chamber 310 of the second rebalancing cell 305 then flows to the positive electrolyte chamber 160 of the rebalancing cell 110 and back to the positive electrolyte tank 120.

Hydrogen gas flows from the tank headspace to the hydrogen chamber 180 in the rebalancing cell 110 through open valves 390, 395, 400, and from the hydrogen chamber 180 to the hydrogen source and/or compressor 215 through open valve 410. Valve 415 is closed to prevent hydrogen flow from the tank headspace to the hydrogen source and/or compressor 215. Hydrogen flows from the hydrogen source and/or compressor 215 through open valves 420, 425, 430 to the tank headspace. Valve 435 is open to allow hydrogen to flow from the tank headspace to the hydrogen chamber 315 of the second rebalancing cell 305. Hydrogen from the hydrogen chamber 315 of the second rebalancing cell 305 flows through valve 475, 425, 430 to the tank headspace. There can be an open valve 440 on the connector 210 between the headspace 200 of the negative electrolyte tank 115 and the headspace 205 of the positive electrolyte tank 120.

The flow of the positive electrolyte and the negative electrolyte from the main cell to the rebalancing cells 110 and 305 can be controlled by a controller 485. The controller 485 can control the various valves allowing flow of some, all, or none of the positive electrolyte and negative electrolyte to flow to the rebalancing cell 110 and the second rebalancing cell 305 depending on the mode of operation as discussed above. In addition to controlling the valves allowing and/or restricting electrolyte flow, the controller 485 can control the flow of current to either or both of the rebalancing cells 110 and 305 depending on the mode of operation.

### EXAMPLES

### Example 1 (Using AEM)

The main cell (25 cm² active area) comprised an iron-based negative electrolyte coupled with the negative electrode (3.5 mm thick carbon felt) and an iron-based positive electrolyte coupled with the positive electrode (2.8 mm carbon felt). An anion exchange membrane (Fumasep) separated the two sides of the battery. The positive electrolyte was also connected to the positive side of the rebalancing cell while the H₂ generated on the negative side in the main battery stack was coupled with the negative electrode of the rebalancing cell. A third chamber in the rebalancing cell comprised the negative electrolyte flowing from the negative electrolyte in the main cell and returning to the negative electrolyte tank. An anion exchange membrane (Fumasep) separated the positive and negative electrolyte chambers of the rebalancing cell, while there is a Nafion cation exchange membrane between the H₂ side and negative electrolyte chambers. The battery was cycled at 120 mAh/cm² charge capacity at 40° C. using a Bio-logic battery cycler with set cut-off voltage limits.

### Example 2 (Dual H₂R with Carbon Felts in Main Cell)

The main cell (25 cm² active area) comprised an iron-based negative electrolyte coupled with the negative electrode (3.5 mm thick carbon felt) and an iron-based positive electrolyte coupled with the positive electrode (2.8 mm carbon felt). An in-house polyethylene-based microporous separator separated the two sides of the battery. The first rebalancing cell comprised a 3-chambered cell where the positive and negative electrodes are 2.8 mm carbon felts. A negative electrolyte chamber was present between the positive and H₂ chambers and was separated from either side by Nafion cation exchange membranes. A second 2-chambered rebalancing cell comprised a positive chamber and a H₂ chamber where both sides were separated by a Nafion cation exchange membrane. The positive electrolyte flowed from the positive electrolyte tank to the positive chamber of the main cell, then to the positive chamber of the second rebalancing cell, and finally back to the positive electrolyte tank. The negative electrolyte flowed from the negative electrolyte tank to the negative chamber of the main cell, then to the negative chamber of the first rebalancing cell and finally back to the negative electrolyte tank. The battery was cycled at 120 mAh/cm² between RT and 40° C. using a Bio-logic battery cycler. The current to the rebalancing cells was controlled using a relay switch to control pH in the negative electrolyte between 3.9 and 4.0 in such a way that one cell was “active” and the other was switched off. The cell was successfully cycled for more than 35 cycles with average CE of about 90% and EE of about 70%.

### Example 3 (Dual H₂R with Carbon Fabric in Main Cell)

The main cell (25 cm² active area) comprised an iron-based negative electrolyte coupled with the negative electrode (1.5 mm thick carbon fabric-based electrode), and an iron-based positive electrolyte coupled with the positive electrode (2.8 mm carbon felt). An in-house polyethylene-based microporous separator separated the two sides of the battery. The first rebalancing cell comprised a 3-chambered cell where the positive and negative electrodes are 2.8 mm carbon felts. A negative electrolyte chamber was present between the positive and H₂ chambers and was separated from either side by Nafion cation exchange membranes. A second 2-chambered rebalancing cell comprised a positive chamber and a H₂ chamber where both sides were separated by a Nafion cation exchange membrane. The positive electrolyte flowed from the positive electrolyte tank to the positive chamber of the main cell, then to the positive chamber of the second rebalancing cell, and finally back to the positive electrolyte tank. The negative electrolyte was flowed from the negative electrolyte tank to the negative chamber of the main cell, then to the negative chamber of the first rebalancing cell and finally back to the negative electrolyte tank. The battery was cycled at 120 mAh/cm² between RT and 40° C. using a Bio-logic battery cycler. The current to the rebalancing cells was controlled using a relay switch to control pH in the negative electrolyte between 3.9 and 4.0 in such a way that one cell was “active” and the other was switched off. The cell was successfully cycled for more than 18 cycles with average CE of about 92% and EE of about 70%.

### SPECIFIC EMBODIMENTS

While the following is described in conjunction with specific embodiments, it will be understood that this description is intended to illustrate and not limit the scope of the preceding description and the appended claims.

A first embodiment of the invention is a system comprising a rechargeable main cell comprising a negative electrode, a positive electrode, a separator, a negative electrolyte chamber, a positive electrolyte chamber, a negative electrolyte tank, and a positive electrolyte tank, the negative electrolyte chamber positioned between the negative electrode and the separator, the separator positioned between the negative electrolyte chamber and the positive electrolyte chamber, the positive electrolyte chamber positioned between the separator and the positive electrode, a rebalancing cell comprising a negative electrode, a positive electrode, a negative electrolyte chamber, a positive electrolyte chamber, a first separator, a second separator, and a hydrogen chamber, the positive electrolyte chamber positioned between the positive electrode and the first separator, the first separator positioned between the positive electrolyte chamber and the negative electrolyte chamber, the second separator positioned between the negative electrolyte chamber and the hydrogen chamber, and the hydrogen chamber positioned between the second separator and the negative electrode; the positive electrolyte chamber of the main cell being in downstream fluid communication with the positive electrolyte tank, the negative electrolyte chamber of the main cell being in downstream fluid communication with the negative electrolyte tank; the positive electrolyte chamber of the rebalancing cell being in downstream fluid communication with the positive electrolyte chamber of the main cell, the negative electrolyte chamber of the rebalancing cell being in downstream fluid communication with the negative electrolyte chamber of the main cell; the positive electrolyte tank being in downstream fluid communication with the positive electrolyte chamber of the rebalancing cell, the negative electrolyte tank being in downstream fluid communication with the negative electrolyte chamber of the rebalancing cell; the hydrogen chamber of the rebalancing cell being in downstream fluid communication with a tank headspace, and the tank headspace being in downstream fluid communication with the hydrogen chamber of the rebalancing cell, the tank headspace comprising a headspace of the negative electrolyte tank, or a headspace of the positive electrolyte tank, or a connector between the headspace of the negative electrolyte tank and the headspace of the positive electrolyte tank, or combinations thereof; wherein when the separator of the main cell comprises a proton exchange membrane, a cation exchange membrane, or a microporous separator, the first separator of the rebalancing cell comprises a proton exchange membrane, a cation exchange membrane, or a microporous separator, and the second separator of the rebalancing cell comprises a proton exchange membrane, a cation exchange membrane, or a microporous separator; and when the separator of the main cell comprises an anion exchange membrane, the first separator of the rebalancing cell comprises an anion exchange membrane and the second separator of the rebalancing cell comprises a proton exchange membrane, a cation exchange membrane, or a microporous separator. An embodiment of the invention is one, any or all of prior embodiments in this paragraph up through the first embodiment in this paragraph further comprising a second rebalancing cell comprising a negative electrode, a positive electrode, a separator, a positive electrolyte chamber, and a hydrogen chamber, the positive electrolyte chamber being positioned between the positive electrode and the separator, the separator being positioned between the positive electrolyte chamber and the hydrogen chamber, and the hydrogen chamber being positioned between the separator and the negative electrode; the positive electrolyte chamber of the main cell being in selective downstream fluid communication with the positive electrolyte tank, the negative electrolyte chamber of the main cell being in selective downstream fluid communication with the negative electrolyte tank; the positive electrolyte chamber of the rebalancing cell being in selective downstream fluid communication with the positive electrolyte chamber of the main cell, the negative electrolyte chamber of the rebalancing cell being in selective downstream fluid communication with the negative electrolyte chamber of the main cell; the positive electrolyte chamber of the second rebalancing cell being in selective downstream fluid communication with the positive electrolyte chamber of the main cell, or the positive electrolyte chamber of the rebalancing cell, or both; the positive electrolyte tank being in selective downstream fluid communication with the positive electrolyte chamber of the rebalancing cell, or the positive electrolyte chamber of the second rebalancing cell, or both; the negative electrolyte tank being in selective downstream fluid communication with the negative electrolyte chamber of the rebalancing cell or the negative electrolyte chamber of the main cell; the hydrogen chamber of the rebalancing cell being in selective downstream fluid communication with the tank headspace, and the tank headspace being in selective downstream fluid communication with the hydrogen chamber of the rebalancing cell; a hydrogen source, a compressor, or both being in being in selective downstream fluid communication with the tank headspace, and the tank headspace being in selective downstream fluid communication with the hydrogen source, the compressor, or both; the hydrogen chamber of the second rebalancing cell being in selective downstream communication with the tank headspace and the tank headspace being in selective downstream communication with the hydrogen chamber of the second rebalancing cell. An embodiment of the invention is one, any or all of prior embodiments in this paragraph up through the first embodiment in this paragraph wherein alternately the selective downstream fluid communication of the positive electrolyte chamber of the rebalancing cell with the positive electrolyte chamber of the main cell to is open, the selective downstream fluid communication of the negative electrolyte chamber of the rebalancing cell with the negative electrolyte chamber of the main cell is open, the selective downstream fluid communication of the negative electrolyte tank with the negative electrolyte chamber of the rebalancing cell is open, the selective downstream fluid communication of the positive electrolyte tank with the positive electrolyte chamber of the rebalancing cell is open; the selective downstream fluid communication of the negative electrolyte tank with the negative electrolyte chamber of the main cell is closed, and the selective downstream fluid communication of the positive electrolyte chamber of the second rebalancing cell with the positive electrolyte chamber of the main cell is closed, the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, and the selective downstream fluid communication of the hydrogen chamber of the second rebalancing cell with the tank head space is closed, and the selective downstream fluid communication of the hydrogen source, the compressor, or both with the tank head space is closed; or the selective downstream fluid communication of the positive electrolyte chamber of the second rebalancing cell with the positive electrolyte chamber of the main cell is open, the selective downstream fluid communication of the negative electrolyte tank with the negative electrolyte chamber of the main cell is open, the selective downstream fluid communication of the positive electrolyte chamber of the rebalancing cell with the positive electrolyte chamber of the main cell to is closed, and the selective downstream fluid communication of the negative electrolyte chamber of the rebalancing cell with the negative electrolyte chamber of the main cell is closed, the selective downstream fluid communication of the hydrogen chamber of the second rebalancing cell with the tank head space is open, the selective downstream fluid communication of the tank headspace with the hydrogen chamber of the second rebalancing cell is open, the selective downstream fluid communication of the hydrogen source, the compressor, or both with the tank head space is open, the selective downstream fluid communication of the tank headspace with the hydrogen source, the compressor, or both is open, and the selective downstream fluid communication of the hydrogen chamber of the rebalancing cell with the tank head space is closed. An embodiment of the invention is one, any or all of prior embodiments in this paragraph up through the first embodiment in this paragraph wherein the selective downstream fluid communication of the positive electrolyte chamber of the rebalancing cell with the positive electrolyte chamber of the main cell is open, the selective downstream fluid communication of the negative electrolyte chamber of the rebalancing cell with the negative electrolyte chamber of the main cell is open, the selective downstream fluid communication of the positive electrolyte chamber of the second rebalancing cell with the positive electrolyte chamber of the main cell is open, the selective downstream fluid communication of the positive electrolyte tank with the positive electrolyte chamber of the rebalancing cell is open, the selective downstream fluid communication of the positive electrolyte tank with the positive electrolyte chamber of the second rebalancing cell is open, the selective downstream fluid communication of the negative electrolyte tank with the negative electrolyte chamber of the rebalancing cell is open, the selective downstream fluid communication of the negative electrolyte tank with the negative electrolyte chamber of the main cell is open; and the selective downstream fluid communication of the positive electrolyte chamber of the second rebalancing cell with the positive electrolyte chamber of the rebalancing cell is closed; the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, the selective downstream fluid communication of the hydrogen source, the compressor, or both with the tank head space is open, the selective downstream fluid communication of the hydrogen chamber of the second rebalancing cell with the tank head space is open, the selective downstream fluid communication of the tank headspace with the hydrogen chamber of the second rebalancing cell is open, and the selective downstream fluid communication of the hydrogen source, the compressor, or both with the tank head space is closed. An embodiment of the invention is one, any or all of prior embodiments in this paragraph up through the first embodiment in this paragraph wherein the selective downstream fluid communication of the positive electrolyte chamber of the rebalancing cell with the positive electrolyte chamber of the main cell is open, the selective downstream fluid communication of the negative electrolyte chamber of the rebalancing cell with the negative electrolyte chamber of the main cell is open, the selective downstream fluid communication of the positive electrolyte chamber of the second rebalancing cell with the positive electrolyte chamber of the rebalancing cell is open, the selective downstream fluid communication of the positive electrolyte tank with the positive electrolyte chamber of the second rebalancing cell is open, the selective downstream fluid communication of the negative electrolyte tank with the negative electrolyte chamber of the rebalancing cell is open, the selective downstream fluid communication of the negative electrolyte tank with the negative electrolyte chamber of the main cell is closed, the selective downstream fluid communication of the positive electrolyte chamber of the second rebalancing cell with the positive electrolyte chamber of the main cell is closed, and the selective downstream fluid communication of the positive electrolyte tank with the positive electrolyte chamber of the rebalancing cell is closed, the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, the selective downstream fluid communication of the hydrogen source, the compressor, or both with the tank head space is open, the selective downstream fluid communication of the hydrogen chamber of the second rebalancing cell with the tank head space is open, the selective downstream fluid communication of the tank headspace with the hydrogen chamber of the second rebalancing cell is open, and the selective downstream fluid communication of the hydrogen source, the compressor, or both with the tank head space is closed. An embodiment of the invention is one, any or all of prior embodiments in this paragraph up through the first embodiment in this paragraph wherein the separator in the second rebalancing cell comprises a proton exchange membrane, a cation exchange membrane, or a microporous separator. An embodiment of the invention is one, any or all of prior embodiments in this paragraph up through the first embodiment in this paragraph wherein the negative electrolyte chamber of the rebalancing cell is in downstream fluid communication with the negative electrolyte chamber of the main cell only when the positive electrolyte chamber of the rebalancing cell is in downstream fluid communication with the positive electrolyte chamber of the main cell. An embodiment of the invention is one, any or all of prior embodiments in this paragraph up through the first embodiment in this paragraph wherein the negative electrolyte chamber of the rebalancing cell is in constant downstream fluid communication with the negative electrolyte chamber of the main cell. An embodiment of the invention is one, any or all of prior embodiments in this paragraph up through the first embodiment in this paragraph further comprising a sensor, and a controller in communication with the sensor and at least one valve.

A second embodiment of the invention is a method of operating a redox flow battery comprising providing a redox flow battery comprising a rechargeable main cell comprising a negative electrode, a positive electrode, a separator, a negative electrolyte chamber, a positive electrolyte chamber, a negative electrolyte tank, and a positive electrolyte tank, the negative electrolyte chamber positioned between the negative electrode and the separator, the separator positioned between the negative electrolyte chamber and the positive electrolyte chamber, the positive electrolyte chamber positioned between the separator and the positive electrode, a rebalancing cell comprising a negative electrode, a positive electrode, a negative electrolyte chamber, a positive electrolyte chamber, a first separator, a second separator, and a hydrogen chamber, the positive electrolyte chamber positioned between the positive electrode and the first separator, the first separator positioned between the positive electrolyte chamber and the negative electrolyte chamber, the second separator positioned between the negative electrolyte chamber and the hydrogen chamber, and the hydrogen chamber positioned between the second separator and the negative electrode; the positive electrolyte chamber of the main cell being in downstream fluid communication with the positive electrolyte tank, the negative electrolyte chamber of the main cell being in downstream fluid communication with the negative electrolyte tank; the positive electrolyte chamber of the rebalancing cell being in downstream fluid communication with the positive electrolyte chamber of the main cell, the negative electrolyte chamber of the rebalancing cell being in downstream fluid communication with the negative electrolyte chamber of the main cell; the positive electrolyte tank being in downstream fluid communication with the positive electrolyte chamber of the rebalancing cell, the negative electrolyte tank being in downstream fluid communication with the negative electrolyte chamber of the rebalancing cell; the hydrogen chamber of the rebalancing cell being in downstream fluid communication with a tank headspace, and the tank headspace being in downstream fluid communication with the hydrogen chamber of the rebalancing cell, the tank headspace comprising a headspace of the negative electrolyte tank, or a headspace of the positive electrolyte tank, or a connector between the headspace of the negative electrolyte tank and the headspace of the positive electrolyte tank, or combinations thereof; wherein when the separator of the main cell comprises a proton exchange membrane, a cation exchange membrane, or a microporous separator, the first separator of the rebalancing cell comprises a proton exchange membrane, a cation exchange membrane, or a microporous separator, and the second separator of the rebalancing cell comprises a proton exchange membrane, a cation exchange membrane, or a microporous separator and when the separator of the main cell comprises an anion exchange membrane, the first separator of the rebalancing cell comprises an anion exchange membrane and the second separator of the rebalancing cell comprises a proton exchange membrane, a cation exchange membrane, or a microporous separator; introducing negative electrolyte from the negative electrolyte tank to the negative electrolyte chamber of the main cell and introducing positive electrolyte from the positive electrolyte tank to the positive electrolyte chamber of the main cell; introducing negative electrolyte from the negative electrolyte chamber of the main cell to the negative electrolyte chamber of the rebalancing cell and introducing positive electrolyte from the positive electrolyte chamber of the main cell to the positive electrolyte chamber of the rebalancing cell; introducing negative electrolyte from the negative electrolyte chamber of the rebalancing cell to the negative electrolyte tank and introducing positive electrolyte from the positive electrolyte chamber of the rebalancing cell to the positive electrolyte tank; introducing hydrogen from the tank headspace to the hydrogen chamber of the rebalancing cell; and introducing hydrogen from the hydrogen chamber of the rebalancing cell to the tank headspace. An embodiment of the invention is one, any or all of prior embodiments in this paragraph up through the second embodiment in this paragraph wherein the redox flow battery further comprises a second rebalancing cell comprising a negative electrode, a positive electrode, a separator, a positive electrolyte chamber, and a hydrogen chamber, the positive electrolyte chamber being positioned between the positive electrode and the separator, the separator being positioned between the positive electrolyte chamber and the hydrogen chamber, and the hydrogen chamber being positioned between the separator and the negative electrode the positive electrolyte chamber of the main cell being in selective downstream fluid communication with the positive electrolyte tank, the negative electrolyte chamber of the main cell being in selective downstream fluid communication with the negative electrolyte tank; the positive electrolyte chamber of the rebalancing cell being in selective downstream fluid communication with the positive electrolyte chamber of the main cell, the negative electrolyte chamber of the rebalancing cell being in selective downstream fluid communication with the negative electrolyte chamber of the main cell; the positive electrolyte chamber of the second rebalancing cell being in selective downstream fluid communication with the positive electrolyte chamber of the main cell, or the positive electrolyte chamber of the rebalancing cell, or both; the positive electrolyte tank being in selective downstream fluid communication with the positive electrolyte chamber of the rebalancing cell, or the positive electrolyte chamber of the second rebalancing cell, or both; the negative electrolyte tank being in selective downstream fluid communication with the negative electrolyte chamber of the rebalancing cell or the negative electrolyte chamber of the main cell; the hydrogen chamber of the rebalancing cell being in selective downstream fluid communication with the tank headspace, and the tank headspace being in selective downstream fluid communication with the hydrogen chamber of the rebalancing cell; a hydrogen source, a compressor, or both being in being in selective downstream fluid communication with the tank headspace, and the tank headspace being in selective downstream fluid communication with the hydrogen source, the compressor, or both; the hydrogen chamber of the second rebalancing cell being in selective downstream communication with the tank headspace and the tank headspace being in selective downstream communication with the hydrogen chamber of the second rebalancing cell; An embodiment of the invention is one, any or all of prior embodiments in this paragraph up through the second embodiment in this paragraph alternately selectively introducing the negative electrolyte from the negative electrolyte tank to the negative electrolyte chamber of the main cell and selectively introducing the positive electrolyte from the positive electrolyte tank to the positive electrolyte chamber of the main cell; selectively introducing the negative electrolyte from the negative electrolyte chamber of the main cell to the negative electrolyte chamber of the rebalancing cell and selectively introducing the positive electrolyte from the positive electrolyte chamber of the main cell to the positive electrolyte chamber of the rebalancing cell; selectively introducing the negative electrolyte from the negative electrolyte chamber of the rebalancing cell to the negative electrolyte tank and selectively introducing the positive electrolyte from the positive electrolyte chamber of the rebalancing cell to the positive electrolyte tank; selectively introducing the hydrogen from the tank headspace to the hydrogen chamber of the rebalancing cell; selectively introducing the hydrogen from the hydrogen chamber of the rebalancing cell to the tank headspace; or selectively introducing the negative electrolyte from the negative electrolyte tank to the negative electrolyte chamber of the main cell and selectively introducing the positive electrolyte from the positive electrolyte tank to the positive electrolyte chamber of the main cell; selectively introducing the negative electrolyte from the negative electrolyte chamber of the main cell to the negative electrolyte tank and selectively introducing the positive electrolyte from the positive electrolyte chamber of the main cell to the positive electrolyte chamber of the second rebalancing cell, and selectively introducing the positive electrolyte from the positive electrolyte chamber of the second rebalancing cell to the positive electrolyte tank; selectively introducing the hydrogen from the tank headspace to the hydrogen chamber of the second rebalancing cell; and selectively introducing the hydrogen from the hydrogen chamber of the second rebalancing cell to the tank headspace. An embodiment of the invention is one, any or all of prior embodiments in this paragraph up through the second embodiment in this paragraph further comprising introducing the negative electrolyte from the negative electrolyte chamber of the main cell to the negative electrolyte tank and introducing the positive electrolyte from the positive electrolyte chamber of the main cell to the positive electrolyte chamber of the second rebalancing cell, and introducing the positive electrolyte from the positive electrolyte chamber of the second rebalancing cell to the positive electrolyte tank; introducing the hydrogen from the tank headspace to the hydrogen chamber of the second rebalancing cell; and introducing the hydrogen from the hydrogen chamber of the second rebalancing cell to the tank headspace. An embodiment of the invention is one, any or all of prior embodiments in this paragraph up through the second embodiment in this paragraph further comprising introducing the negative electrolyte from the negative electrolyte chamber of the main cell to the negative electrolyte tank and introducing the positive electrolyte from the positive electrolyte chamber of the rebalancing cell to the positive electrolyte chamber of the second rebalancing cell, and introducing the positive electrolyte from the positive electrolyte chamber of the second rebalancing cell to the positive electrolyte tank; introducing the hydrogen from the tank headspace to the hydrogen chamber of the second rebalancing cell; and introducing the hydrogen from the hydrogen chamber of the second rebalancing cell to the tank headspace. An embodiment of the invention is one, any or all of prior embodiments in this paragraph up through the second embodiment in this paragraph further comprising controlling a flow of the negative electrolyte from the negative electrolyte chamber of the main cell to the negative electrolyte chamber of the rebalancing cell and the negative electrolyte tank; and controlling a flow of the positive electrolyte from the positive electrolyte chamber of the main cell to the positive electrolyte chamber of the rebalancing cell and the positive electrolyte chamber of the second rebalancing cell. An embodiment of the invention is one, any or all of prior embodiments in this paragraph up through the second embodiment in this paragraph wherein the negative electrolyte chamber of the rebalancing cell is in downstream fluid communication with the negative electrolyte chamber of the main cell only when the positive electrolyte chamber of the rebalancing cell is in downstream fluid communication with the positive electrolyte chamber of the main cell. An embodiment of the invention is one, any or all of prior embodiments in this paragraph up through the second embodiment in this paragraph wherein the negative electrolyte chamber of the rebalancing cell is in constant downstream fluid communication with the negative electrolyte chamber of the main cell. An embodiment of the invention is one, any or all of prior embodiments in this paragraph up through the second embodiment in this paragraph wherein the separator in the second rebalancing cell comprises a proton exchange membrane, a cation exchange membrane, or a microporous separator. An embodiment of the invention is one, any or all of prior embodiments in this paragraph up through the second embodiment in this paragraph further comprising a hydrogen source, a compressor, or both, wherein the hydrogen source, the compressor, or both is in downstream fluid communication with the tank headspace, and the tank headspace is in downstream fluid communication with the hydrogen source, the compressor, or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A redox flow battery system comprising:
a rechargeable main cell comprising a negative electrode, a positive electrode, a separator, a negative electrolyte chamber, a positive electrolyte chamber, a negative electrolyte tank, and a positive electrolyte tank, the negative electrolyte chamber positioned between the negative electrode and the separator, the separator positioned between the negative electrolyte chamber and the positive electrolyte chamber, the positive electrolyte chamber positioned between the separator and the positive electrode, a rebalancing cell comprising a negative electrode, a positive electrode, a negative electrolyte chamber, a positive electrolyte chamber, a first separator, a second separator, and a hydrogen chamber, the positive electrolyte chamber positioned between the positive electrode and the first separator, the first separator positioned between the positive electrolyte chamber and the negative electrolyte chamber, the second separator positioned between the negative electrolyte chamber and the hydrogen chamber, and the hydrogen chamber positioned between the second separator and the negative electrode;
the positive electrolyte chamber of the main cell being in downstream fluid communication with the positive electrolyte tank, the negative electrolyte chamber of the main cell being in downstream fluid communication with the negative electrolyte tank;
the positive electrolyte chamber of the rebalancing cell being in downstream fluid communication with the positive electrolyte chamber of the main cell, the negative electrolyte chamber of the rebalancing cell being in downstream fluid communication with the negative electrolyte chamber of the main cell;
the positive electrolyte tank being in downstream fluid communication with the positive electrolyte chamber of the rebalancing cell, the negative electrolyte tank being in downstream fluid communication with the negative electrolyte chamber of the rebalancing cell;
the hydrogen chamber of the rebalancing cell being in downstream fluid communication with a tank headspace, and the tank headspace being in downstream fluid communication with the hydrogen chamber of the rebalancing cell, the tank headspace comprising a headspace of the negative electrolyte tank, or a headspace of the positive electrolyte tank, or a connector between the headspace of the negative electrolyte tank and the headspace of the positive electrolyte tank, or combinations thereof;
wherein:
when the separator of the main cell comprises a proton exchange membrane, a cation exchange membrane, or a microporous separator, the first separator of the rebalancing cell comprises a proton exchange membrane, a cation exchange membrane, or a microporous separator, and the second separator of the rebalancing cell comprises a proton exchange membrane, a cation exchange membrane, or a microporous separator; and
when the separator of the main cell comprises an anion exchange membrane, the first separator of the rebalancing cell comprises an anion exchange membrane and the second separator of the rebalancing cell comprises a proton exchange membrane, a cation exchange membrane, or a microporous separator.

2. The redox flow battery system of claim 1 further comprising:
a second rebalancing cell comprising a negative electrode, a positive electrode, a separator, a positive electrolyte chamber, and a hydrogen chamber, the positive electrolyte chamber being positioned between the positive electrode and the separator, the separator being positioned between the positive electrolyte chamber and the hydrogen chamber, and the hydrogen chamber being positioned between the separator and the negative electrode;
the positive electrolyte chamber of the main cell being in selective downstream fluid communication with the positive electrolyte tank, the negative electrolyte chamber of the main cell being in selective downstream fluid communication with the negative electrolyte tank;
the positive electrolyte chamber of the rebalancing cell being in selective downstream fluid communication with the positive electrolyte chamber of the main cell, the negative electrolyte chamber of the rebalancing cell being in selective downstream fluid communication with the negative electrolyte chamber of the main cell;
the positive electrolyte chamber of the second rebalancing cell being in selective downstream fluid communication with the positive electrolyte chamber of the main cell, or the positive electrolyte chamber of the rebalancing cell, or both;
the positive electrolyte tank being in selective downstream fluid communication with the positive electrolyte chamber of the rebalancing cell, or the positive electrolyte chamber of the second rebalancing cell, or both;
the negative electrolyte tank being in selective downstream fluid communication with the negative electrolyte chamber of the rebalancing cell or the negative electrolyte chamber of the main cell;
the hydrogen chamber of the rebalancing cell being in selective downstream fluid communication with the tank headspace, and the tank headspace being in selective downstream fluid communication with the hydrogen chamber of the rebalancing cell;
a hydrogen source, a compressor, or both being in being in selective downstream fluid communication with the tank headspace, and the tank headspace being in selective downstream fluid communication with the hydrogen source, the compressor, or both; and
the hydrogen chamber of the second rebalancing cell being in selective downstream communication with the tank headspace and the tank headspace being in selective downstream communication with the hydrogen chamber of the second rebalancing cell.

3. The redox flow battery system of claim 2 wherein alternately:
the selective downstream fluid communication of the positive electrolyte chamber of the rebalancing cell with the positive electrolyte chamber of the main cell to is open, the selective downstream fluid communication of the negative electrolyte chamber of the rebalancing cell with the negative electrolyte chamber of the main cell is open, the selective downstream fluid communication of the negative electrolyte tank with the negative electrolyte chamber of the rebalancing cell is open, the selective downstream fluid communication of the positive electrolyte tank with the positive electrolyte chamber of the rebalancing cell is open; the selective downstream fluid communication of the negative electrolyte tank with the negative electrolyte chamber of the main cell is closed, and the selective downstream fluid communication of the positive electrolyte chamber of the second rebalancing cell with the positive electrolyte chamber of the main cell is closed,
the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, and
the selective downstream fluid communication of the hydrogen chamber of the second rebalancing cell with the tank head space is closed, and the selective downstream fluid communication of the hydrogen source, the compressor, or both with the tank head space is closed;
or
the selective downstream fluid communication of the positive electrolyte chamber of the second rebalancing cell with the positive electrolyte chamber of the main cell is open, the selective downstream fluid communication of the negative electrolyte tank with the negative electrolyte chamber of the main cell is open, the selective downstream fluid communication of the positive electrolyte chamber of the rebalancing cell with the positive electrolyte chamber of the main cell to is closed, and the selective downstream fluid communication of the negative electrolyte chamber of the rebalancing cell with the negative electrolyte chamber of the main cell is closed,
the selective downstream fluid communication of the hydrogen chamber of the second rebalancing cell with the tank head space is open, the selective downstream fluid communication of the tank headspace with the hydrogen chamber of the second rebalancing cell is open, the selective downstream fluid communication of the hydrogen source, the compressor, or both with the tank head space is open, the selective downstream fluid communication of the tank headspace with the hydrogen source, the compressor, or both is open, and
the selective downstream fluid communication of the hydrogen chamber of the rebalancing cell with the tank head space is closed.

4. The redox flow battery system of claim 2 wherein:
the selective downstream fluid communication of the positive electrolyte chamber of the rebalancing cell with the positive electrolyte chamber of the main cell is open, the selective downstream fluid communication of the negative electrolyte chamber of the rebalancing cell with the negative electrolyte chamber of the main cell is open, the selective downstream fluid communication of the positive electrolyte chamber of the second rebalancing cell with the positive electrolyte chamber of the main cell is open, the selective downstream fluid communication of the positive electrolyte tank with the positive electrolyte chamber of the rebalancing cell is open, the selective downstream fluid communication of the positive electrolyte tank with the positive electrolyte chamber of the second rebalancing cell is open, the selective downstream fluid communication of the negative electrolyte tank with the negative electrolyte chamber of the rebalancing cell is open, the selective downstream fluid communication of the negative electrolyte tank with the negative electrolyte chamber of the main cell is open;
the selective downstream fluid communication of the positive electrolyte chamber of the second rebalancing cell with the positive electrolyte chamber of the rebalancing cell is closed;
the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, the selective downstream fluid communication of the hydrogen source, the compressor, or both with the tank head space is open, the selective downstream fluid communication of the hydrogen chamber of the second rebalancing cell with the tank head space is open, the selective downstream fluid communication of the tank headspace with the hydrogen chamber of the second rebalancing cell is open, and
the selective downstream fluid communication of the hydrogen source, the compressor, or both with the tank head space is closed.

5. The redox flow battery system of claim 3 wherein:
the selective downstream fluid communication of the positive electrolyte chamber of the rebalancing cell with the positive electrolyte chamber of the main cell is open, the selective downstream fluid communication of the negative electrolyte chamber of the rebalancing cell with the negative electrolyte chamber of the main cell is open, the selective downstream fluid communication of the positive electrolyte chamber of the second rebalancing cell with the positive electrolyte chamber of the rebalancing cell is open, the selective downstream fluid communication of the positive electrolyte tank with the positive electrolyte chamber of the second rebalancing cell is open, the selective downstream fluid communication of the negative electrolyte tank with the negative electrolyte chamber of the rebalancing cell is open,
the selective downstream fluid communication of the negative electrolyte tank with the negative electrolyte chamber of the main cell is closed, the selective downstream fluid communication of the positive electrolyte chamber of the second rebalancing cell with the positive electrolyte chamber of the main cell is closed, and the selective downstream fluid communication of the positive electrolyte tank with the positive electrolyte chamber of the rebalancing cell is closed,
the selective downstream fluid communication of the hydrogen chamber of the rebalancing cell with the tank head space is open, the selective downstream fluid communication of the hydrogen source, the compressor, or both with the hydrogen chamber of the rebalancing cell is open, the selective downstream fluid communication of the tank headspace with the hydrogen source, the compressor, or both is open, the selective downstream fluid communication of the hydrogen source, the compressor, or both with the tank head space is open, the selective downstream fluid communication of the hydrogen chamber of the second rebalancing cell with the tank head space is open, the selective downstream fluid communication of the tank headspace with the hydrogen chamber of the second rebalancing cell is open, and
the selective downstream fluid communication of the hydrogen source, the compressor, or both with the tank head space is closed.

6. The redox flow battery system of claim 2 wherein the separator in the second rebalancing cell comprises a proton exchange membrane, a cation exchange membrane, or a microporous separator.

7. The redox flow battery system of claim 2 wherein the negative electrolyte chamber of the rebalancing cell is in downstream fluid communication with the negative electrolyte chamber of the main cell only when the positive electrolyte chamber of the rebalancing cell is in downstream fluid communication with the positive electrolyte chamber of the main cell.

8. The redox flow battery system of claim 2 wherein the negative electrolyte chamber of the rebalancing cell is in constant downstream fluid communication with the negative electrolyte chamber of the main cell.

9. The redox flow battery system of claim 2 further comprising a sensor, and a controller in communication with the sensor and at least one valve.

10. A method of operating a redox flow battery comprising:
providing a redox flow battery system comprising:
a rechargeable main cell comprising a negative electrode, a positive electrode, a separator, a negative electrolyte chamber, a positive electrolyte chamber, a negative electrolyte tank, and a positive electrolyte tank, the negative electrolyte chamber positioned between the negative electrode and the separator, the separator positioned between the negative electrolyte chamber and the positive electrolyte chamber, the positive electrolyte chamber positioned between the separator and the positive electrode, a rebalancing cell comprising a negative electrode, a positive electrode, a negative electrolyte chamber, a positive electrolyte chamber, a first separator, a second separator, and a hydrogen chamber, the positive electrolyte chamber positioned between the positive electrode and the first separator, the first separator positioned between the positive electrolyte chamber and the negative electrolyte chamber, the second separator positioned between the negative electrolyte chamber and the hydrogen chamber, and the hydrogen chamber positioned between the second separator and the negative electrode;
the positive electrolyte chamber of the main cell being in downstream fluid communication with the positive electrolyte tank, the negative electrolyte chamber of the main cell being in downstream fluid communication with the negative electrolyte tank;
the positive electrolyte chamber of the rebalancing cell being in downstream fluid communication with the positive electrolyte chamber of the main cell, the negative electrolyte chamber of the rebalancing cell being in downstream fluid communication with the negative electrolyte chamber of the main cell;
the positive electrolyte tank being in downstream fluid communication with the positive electrolyte chamber of the rebalancing cell, the negative electrolyte tank being in downstream fluid communication with the negative electrolyte chamber of the rebalancing cell;
the hydrogen chamber of the rebalancing cell being in downstream fluid communication with a tank headspace, and the tank headspace being in downstream fluid communication with the hydrogen chamber of the rebalancing cell, the tank headspace comprising a headspace of the negative electrolyte tank, or a headspace of the positive electrolyte tank, or a connector between the headspace of the negative electrolyte tank and the headspace of the positive electrolyte tank, or combinations thereof;
wherein:
when the separator of the main cell comprises a proton exchange membrane, a cation exchange membrane, or a microporous separator, the first separator of the rebalancing cell comprises a proton exchange membrane, a cation exchange membrane, or a microporous separator, and the second separator of the rebalancing cell comprises a proton exchange membrane, a cation exchange membrane, or a microporous separator; and
when the separator of the main cell comprises an anion exchange membrane, the first separator of the rebalancing cell comprises an anion exchange membrane and the second separator of the rebalancing cell comprises a proton exchange membrane, a cation exchange membrane, or a microporous separator;
introducing negative electrolyte from the negative electrolyte tank to the negative electrolyte chamber of the main cell and introducing positive electrolyte from the positive electrolyte tank to the positive electrolyte chamber of the main cell;
introducing negative electrolyte from the negative electrolyte chamber of the main cell to the negative electrolyte chamber of the rebalancing cell and introducing positive electrolyte from the positive electrolyte chamber of the main cell to the positive electrolyte chamber of the rebalancing cell;
introducing negative electrolyte from the negative electrolyte chamber of the rebalancing cell to the negative electrolyte tank and introducing positive electrolyte from the positive electrolyte chamber of the rebalancing cell to the positive electrolyte tank;
introducing hydrogen from the tank headspace to the hydrogen chamber of the rebalancing cell; and
introducing hydrogen from the hydrogen chamber of the rebalancing cell to the tank headspace.

11. The method of claim 10 wherein the redox flow battery system further comprises:
a second rebalancing cell comprising a negative electrode, a positive electrode, a separator, a positive electrolyte chamber, and a hydrogen chamber, the positive electrolyte chamber being positioned between the positive electrode and the separator, the separator being positioned between the positive electrolyte chamber and the hydrogen chamber, and the hydrogen chamber being positioned between the separator and the negative electrode
the positive electrolyte chamber of the main cell being in selective downstream fluid communication with the positive electrolyte tank, the negative electrolyte chamber of the main cell being in selective downstream fluid communication with the negative electrolyte tank;
the positive electrolyte chamber of the rebalancing cell being in selective downstream fluid communication with the positive electrolyte chamber of the main cell, the negative electrolyte chamber of the rebalancing cell being in selective downstream fluid communication with the negative electrolyte chamber of the main cell;
the positive electrolyte chamber of the second rebalancing cell being in selective downstream fluid communication with the positive electrolyte chamber of the main cell, or the positive electrolyte chamber of the rebalancing cell, or both;
the positive electrolyte tank being in selective downstream fluid communication with the positive electrolyte chamber of the rebalancing cell, or the positive electrolyte chamber of the second rebalancing cell, or both;
the negative electrolyte tank being in selective downstream fluid communication with the negative electrolyte chamber of the rebalancing cell or the negative electrolyte chamber of the main cell;
the hydrogen chamber of the rebalancing cell being in selective downstream fluid communication with the tank headspace, and the tank headspace being in selective downstream fluid communication with the hydrogen chamber of the rebalancing cell;
a hydrogen source, a compressor, or both being in being in selective downstream fluid communication with the tank headspace, and the tank headspace being in selective downstream fluid communication with the hydrogen source, the compressor, or both; and
the hydrogen chamber of the second rebalancing cell being in selective downstream communication with the tank headspace and the tank headspace being in selective downstream communication with the hydrogen chamber of the second rebalancing cell.

12. The method of claim 11 alternately:
selectively introducing the negative electrolyte from the negative electrolyte tank to the negative electrolyte chamber of the main cell and selectively introducing the positive electrolyte from the positive electrolyte tank to the positive electrolyte chamber of the main cell;
selectively introducing the negative electrolyte from the negative electrolyte chamber of the main cell to the negative electrolyte chamber of the rebalancing cell and selectively introducing the positive electrolyte from the positive electrolyte chamber of the main cell to the positive electrolyte chamber of the rebalancing cell;
selectively introducing the negative electrolyte from the negative electrolyte chamber of the rebalancing cell to the negative electrolyte tank and selectively introducing the positive electrolyte from the positive electrolyte chamber of the rebalancing cell to the positive electrolyte tank;
selectively introducing the hydrogen from the tank headspace to the hydrogen chamber of the rebalancing cell;
selectively introducing the hydrogen from the hydrogen chamber of the rebalancing cell to the tank headspace; or
selectively introducing the negative electrolyte from the negative electrolyte tank to the negative electrolyte chamber of the main cell and selectively introducing the positive electrolyte from the positive electrolyte tank to the positive electrolyte chamber of the main cell;
selectively introducing the negative electrolyte from the negative electrolyte chamber of the main cell to the negative electrolyte tank and selectively introducing the positive electrolyte from the positive electrolyte chamber of the main cell to the positive electrolyte chamber of the second rebalancing cell, and selectively introducing the positive electrolyte from the positive electrolyte chamber of the second rebalancing cell to the positive electrolyte tank;
selectively introducing the hydrogen from the tank headspace to the hydrogen chamber of the second rebalancing cell; and
selectively introducing the hydrogen from the hydrogen chamber of the second rebalancing cell to the tank headspace.

13. The method of claim 11 further comprising:
introducing the negative electrolyte from the negative electrolyte chamber of the main cell to the negative electrolyte tank and introducing the positive electrolyte from the positive electrolyte chamber of the main cell to the positive electrolyte chamber of the second rebalancing cell, and introducing the positive electrolyte from the positive electrolyte chamber of the second rebalancing cell to the positive electrolyte tank;
introducing the hydrogen from the tank headspace to the hydrogen chamber of the second rebalancing cell; and
introducing the hydrogen from the hydrogen chamber of the second rebalancing cell to the tank headspace.

14. The method of claim 11 further comprising:
introducing the negative electrolyte from the negative electrolyte chamber of the main cell to the negative electrolyte tank and introducing the positive electrolyte from the positive electrolyte chamber of the rebalancing cell to the positive electrolyte chamber of the second rebalancing cell, and introducing the positive electrolyte from the positive electrolyte chamber of the second rebalancing cell to the positive electrolyte tank;
introducing the hydrogen from the tank headspace to the hydrogen chamber of the second rebalancing cell; and
introducing the hydrogen from the hydrogen chamber of the second rebalancing cell to the tank headspace.

15. The method of claim 11 further comprising:
controlling a flow of the negative electrolyte from the negative electrolyte chamber of the main cell to the negative electrolyte chamber of the rebalancing cell and the negative electrolytetank; and
controlling a flow of the positive electrolyte from the positive electrolyte chamber of the main cell to the positive electrolyte chamber of the rebalancing cell and the positive electrolyte chamber of the second rebalancing cell.

16. The redox flow battery system of claim 11 wherein the negative electrolyte chamber of the rebalancing cell is in downstream fluid communication with the negative electrolyte chamber of the main cell only when the positive electrolyte chamber of the rebalancing cell is in downstream fluid communication with the positive electrolyte chamber of the main cell.

17. The method of claim 11 wherein the negative electrolyte chamber of the rebalancing cell is in constant downstream fluid communication with the negative electrolyte chamber of the main cell.

18. The method of claim 10 wherein the separator in the second rebalancing cell comprises a proton exchange membrane, a cation exchange membrane, or a microporous separator.

19. The method of claim 10 further comprising a hydrogen source, a compressor, or both, wherein the hydrogen source, the compressor, or both is in downstream fluid communication with the tank headspace, and the tank headspace is in downstream fluid communication with the hydrogen source, the compressor, or both.
